(19) United States
(12) Patent Application Publication
(10) Pub. No.: US 2004/0165006 A1
(43) Pub. Date: Aug. 26, 2004

(54) Methods and apparatus for an interactive media display

(76) Inventors: Timothy Kirby, Lusk (IE); David Grant, Maynalty (IE); Bernie Goldbach, Kilkenny (IE); John Stanley, Kinsale (IE); Sanjay Manandhar, Arlington, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/622,372

(22) Filed: Jul. 18, 2003

(30) Foreign Application Priority Data
Jul. 19, 2002 (IE) S2002/0605

(51) Int. Cl. G09G 5/00

(52) U.S. Cl. 345/740; 345/810; 345/751

(57) ABSTRACT

Methods and apparatus for an interactive media display utilize a screen that presents a content item to a viewer. The display of the content item is interactive, in that a user may remotely control the content presented on the screen, requesting or changing the displayed content item or in some way controlling the outcome of the content of the screen. The system is device agnostic, in that it operates with a wide variety of user devices, such as mobile phones, personal digital assistants (PDAs) equipped for wireless data access, or other mobile devices. In addition to its device-agnostic capabilities, the present invention is display-agnostic, utilizing, for example, cathode ray tube displays, liquid crystal displays, plasma displays, organic light-emitting diode displays, electronic ink displays, and projection screen displays. In another aspect, the present invention provides methods and apparatus for the generation of an interactive media display.

### FIELD OF THE INVENTION

This invention relates to a display system. In particular, it relates to a system that displays content items for interaction with a viewer.

### CROSS-REFERENCE TO RELATED APPLICATIONS

The present application claims the benefit of and priority to co-pending Irish short-term patent application no. S2002/0605, filed on July, 19, 2002, the entire disclosure of which is incorporated by reference as if set forth in its entirety herein.

### BACKGROUND OF THE INVENTION

Display media are used to inform customers of goods and services that are available for purchase and to provide viewers with entertainment and information. Traditional display media, such as print ads and broadcast commercials, are one-way communications channels: they present an audience with a fixed, unchanging message. A viewer cannot directly interact with the medium, for example, by requesting additional information concerning a particular good or service and have the content of the message change in response to the request. Traditional display media are a natural choice for the delivery of one-way communications, given that the content on a printed piece of paper or a pre-recorded broadcast advertisement is neither easily changed nor easily individualized for members of a target audience.

As large-screen plasma televisions and wall-sized projection displays (hereinafter “screen(s)”) have become more affordable, they have been used to deliver traditional one-way communications to passive audiences. In one application, an administrator configures a screen to display predetermined content items using, for example, a VCR or DVD player with a looped program, essentially treating the screen as a “video billboard.” Delivering a one-way communication using a screen overlooks the screen's inherently dynamic nature and ability to change the content it displays in a real time or near real time manner.

A need therefore exists for methods and apparatus that provide an improved media display, letting one or more viewers interact with the content items provided by the display.

### SUMMARY OF THE INVENTION

The present invention relates- to methods and apparatus for an interactive media display. In brief overview, a screen presents a content item to a viewer. The display of the content item is interactive, in that a user may remotely control the content presented on the screen, requesting or changing the displayed content item or in some way controlling the outcome of the content on the screen. The system is device agnostic, in that it operates with a wide variety of user devices, such as mobile phones, personal digital assistants (PDAs) equipped for wireless data access, or other mobile devices. In addition to its device-agnostic capabilities, the present invention is also display-agnostic, utilizing, for example, cathode ray tube displays, liquid crystal displays, plasma displays, organic light-emitting diode displays, electronic ink displays, and projection screen displays. In another aspect, the present invention provides methods and apparatus for the generation of an interactive media display.

In one aspect, the present invention provides an apparatus for an interactive media display. The apparatus includes a central controller to provide content items for display on a screen, a player controller for receiving the content items from the central controller through a network, and a screen for displaying content specified by the player controller, wherein at least one of the central controller and the player controller is responsive to a user device operable by a user to select the content items for display.

Suitable screens include a cathode ray tube display, a liquid crystal display, a plasma display, an organic light-emitting diode display, an electronic ink display, and a projection screen display. In one embodiment, the user device is a portable communication device, such as a mobile phone, a GSM phone, a fixed line telephone, a handheld computer with wireless data capability, a DTMF-generating apparatus associated with a telephone voice input, and a remote control having an infrared (IR) transmitter. In various embodiments, the user device is operable to generate DTMF tones, SMS messages, or MMS messages to direct the operation of the central controller.

In one embodiment, the central controller executes a program whose output displays at the screen. The central controller may optionally display predetermined material when a user is not selecting content items for display on the screen. In another embodiment, the apparatus includes a second screen for the receipt of content items selected by a user via the user device; the second screen may be mounted on a mobile phone device or the user device.

Suitable content items for use with the present invention include live TV channels, pre-recorded programs, songs, music videos, still images, virtual billboards, and multiplayer interactive games, or pointers to one or more of these items.

In another aspect, the present invention provides a method for an interactive media display. A plurality of content items is organized and provided as a playlist, and the items in the playlist are subsequently sequentially displayed on a screen. A command is received from a remote source, processed, and a new content item is displayed in response to the received command. In one embodiment, the method further includes providing a content item to a user device in response to the received command. Suitable content items include ringtones, WAP content, graphics, and data. In another embodiment, the content item displayed in response to the received command is provided to a second screen, such as a screen mounted on a mobile phone device.

In still another aspect, the present invention provides an apparatus for the generation of an interactive media display including a content system for the creation of a playlist of content items, a network interface for providing the playlist to a display system, and a display system. The display system includes a central controller to provide content items for display on a screen, a player controller for receiving the content items from the central controller through a network, and a screen for displaying content specified by the player controller. The playlist may be transmitted to the central controller for storage. In one embodiment, the apparatus also includes a second screen for the provision of content items selected by a user, such as the screen mounted on a mobile phone device.

In yet another aspect, the present invention provides an apparatus for interactive media display including a player controller in communication with a network, the player controller receiving content items transmitted from a remote database server. The apparatus also includes a screen in communication with the player controller, the screen displaying the received content items. A user device permits the selection of a content item from a displayed menu of content items, and a computational module receives information from the user device and selects a content item for display in response to the received information.

In one embodiment, the apparatus further includes a locker module for storing previously requested content items. In one embodiment, the information received from the user device is provided in extensible Markup Language (XML) or format. In another embodiment, the information received from the user device includes a start time and a reception channel for the desired content. In still another embodiment, the apparatus includes a second screen for the provision of content items selected by a user, such as a screen mounted on a mobile phone device or the user device.

The network may be, for example, the Internet, a public or private switched telephone network (wireline or wireless), or a private wireless network using technologies such as Bluetooth or IEEE 802.11x. The user device may be a telephone or any device capable of generating DTMF tones, SMS messages, or MMS messages. In a further embodiment, the apparatus includes a locker module for storing previously requested content items.

In another aspect, the present invention provides a method for interactive media display. A plurality of selectable content items is indicated on a display screen. A transmission is received over a network in response to a command transmitted by a portable communication device, the transmission including a specification of at least one of the content items. The display of the at least one content item on a display device associated with the portable communication device is facilitated.

The foregoing and other features and advantages of the present invention will be made more apparent from the description, drawings, and claims that follow.

### BRIEF DESCRIPTION OF THE DRAWINGS

The advantages of the invention may be better understood by referring to the following description taken in conjunction with the accompanying drawings in which:

FIG. 1 presents a diagram of an embodiment of an networked display system in accord with the present invention;

FIG. 2 depicts a flowchart of an embodiment of a method for creating a content item playlist in accord with the present invention;

FIG. 3 is a screenshot of a graphical user interface for the creation of a content item playlist in accord with the present invention;

FIG. 4 presents a flowchart of an embodiment of a method for interacting with a networked display system in accord with the present invention; and

FIG. 5 depicts another embodiment of a method for interacting with a networked display system in accord with the present invention.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

The present invention relates to a display system for providing interactive media in public venues. In brief overview, an administrator defines a “playlist” of locally cached or remotely stored content items, such as quizzes or music videos. In accord with the present invention, a content item may be a content item per se or a pointer, such as a hyperlink, to content stored on another computer or storage device. Suitable content items for use with the present invention include live TV channels, pre-recorded programs, songs, music videos, still images, virtual billboards, and multiplayer interactive games, or pointers to one or more of these items.

The playlist is essentially a timeline that specifies a series of content items for sequential presentation for specified durations. The playlist is optionally forwarded to a central site for redistribution to one or more screens. A user interacts with a screen displaying the individual content items of the playlist using a user device and, in some embodiments, interacts with these screens to purchase content for the user device. Once purchased, content is available for future usage in a locker module. Embodiments of the invention are suited for deployment as street signs, portable signs, projections onto a hanging screen, projections onto a wall, signs attached to the sides of motor vehicles, or signs in the headrest of an taxi or airline seat.

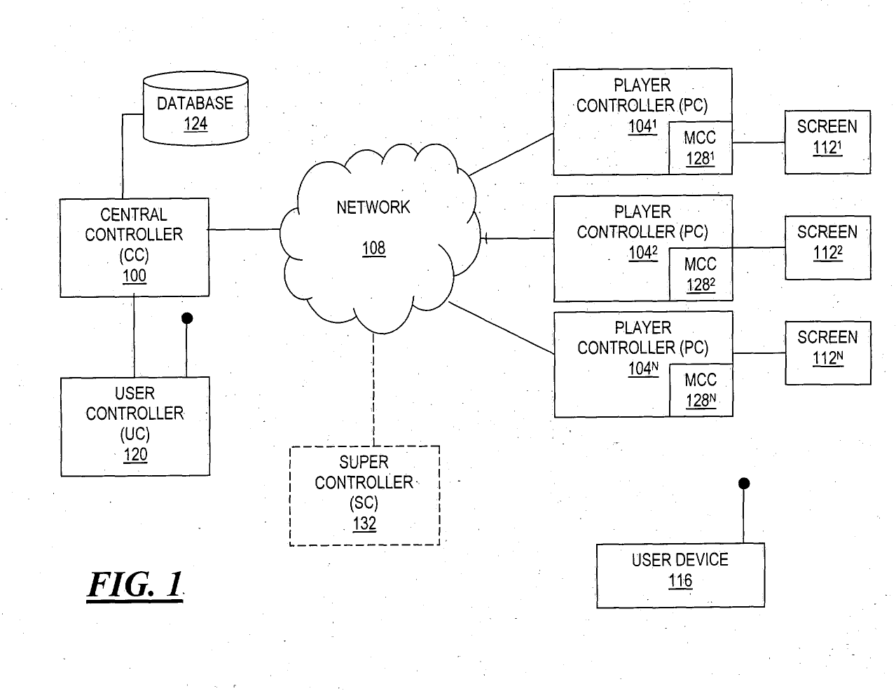

FIG. 1 presents an embodiment of a networked display system in accord with the present invention. The system includes at least one central controller (CC) 100 in communication with at least one player controller (PC) 104¹, 104², 104^{N} (generally 104) through a network 108. Each PC 104 is in communication with one or more screens 112¹, 112², 112^{N} (generally 112). The PC 104 uses its attached screen 112 to display content items for end users having user devices 116. The CC 100 receives commands and other information from end users through communications between their user devices 116 and the user controller (UC) 120.

The CC 100 and PC 104 are typically computers having suitable volatile and nonvolatile storage as well as central processing units (CPUs) capable of executing, e.g., x86, MIPS, ALPHA, PowerPC, or x86-64 machine code and running an operating system such as WINDOWS NT or LINUX, although any combination of hardware and software capable of providing the functionality described hereinbelow may be utilized in accord with the present invention.

The CC 100 serves as the hub for the interactive display system. The CC 100, following a predetermined playlist, provides specified content items in a determined order to a PC 104 for display at a screen 112. In one embodiment, the playlist and content items are stored in one or more databases 124 at the CC 100. In another embodiment, the playlist and content items are stored at a PC 104 and retrieved by the CC 100 on an as-needed basis before processing.

In one embodiment, the CC 100 processes a stored playlist and directly streams content items to the PCs 104 for display at their associated screens 112. In another embodiment, the CC 100 processes a stored playlist containing pointers to content items stored on a PC 104, and provides these pointers to the PC 104 which displays the locally stored content on a screen 112. In still another embodiment, the CC 100 processes a stored playlist containing pointers to content items stored on a PC 104, and provides these pointers to another PC 104′, displaying the remotely stored content on an associated screen 112.

The CC 100 receives commands from at least one user device 116 via UC 120, processes or translates these commands with respect to the active content item displayed from the playlist, and provides the result to a PC 104 for display at the associated screens 112. This processing may include spell checking and removing obscenities from received commands or messages. In a further embodiment, the CC 100 includes logging functionality to record its interactions with a user device 116 or sign 112 for later study or analysis. In still another embodiment, the processing of the received commands occurs in part at the PC 104, which receives the commands directly from a user device 116 and provides the raw or processed information to a CC 100.

The CC 100 and PC 104 have network interfaces, such as gigabit Ethernet or ATM, that permit them to communicate over a network 108. Network 108 may be a virtual private network (VPN) over a packet-based connectionless public network (such as the Internet), or it may be a circuit-based connection over the public switched telephone network (PSTN), ISDN, or DSL. Network 108 may incorporate any number of wireless and wired technologies, including satellite communications, GPRS, WiFi, and mesh network systems, enabling the provision of services to PCs 104 and user devices 116 deployed virtually anywhere in the world. In one embodiment CC 100 and PC 104 are colocated, permitting the direct connection of CC 100 to PC 104 and bypassing the network 108.

Utilizing a public network such as the Internet for transmissions also provides the CC 100 with a direct path for the transmission of content items to a user device 116. Thus, in accord with the present invention, users may view selected content on a screen 112 connected to a PC 104 or on another device, such as a cell phone having a web browser, that is not directly connected to a PC 104. This permits a user, for example, to order ringtones or pictures from the system that are directly transmitted to a user's cell phone, which may, in fact, be the user device 116. The UC 120 may also communicate with the user device 116 using a communication module, permitting direct wireless communications with the user device 116 without using the network 108.

Having network interfaces, each CC 100 and PC 104 also has a network address that is used to control the routing of messages between a CC 100 and a PC 104 or between multiple PCs 104. Having a network address also facilitates the administration of the CC 100 or a PC 104. For example, the presence of a network address for each device enables the provision of a grouping feature to manage several different (and possibly disparate) PCs 104 as a single entity. To enable grouping, an administrator using a CC 100, or in some embodiments' a PC 104, defines a group and assigns a plurality of PCs 104 to the group by specifying the addresses of the PCs 104. Then, an administrator operating a CC 100 utilizes the defined grouping to simultaneously control the content displayed by a plurality of signs 112, such that each sigh in the group behaves substantially similarly, displaying the similar content items in a playlist at the same times.

The CC 100 transmits content items to a PC 104 through the network 108 using, for example, in-memory XML or HyperText Markup Language (HTML) structures over protocols such as HTTP over TCP/IP or UDP/IP. These in-memory XML structures are also used to send revised playlists between a CC 100 and a PC 104. The CC also issues commands to PCs 104 using UDP, for example, instructing a PC 104 to use a new playlist.

A locker module at the CC 100 implements a personalized locker facility for users that interact with the system. The locker stores details concerning a user's previous interactions with the system, so that the user may log into the system and retrieve previously viewed or ordered content by viewing the locker. The locker also contains a logging module that records a user's interactions with the locker for subsequent review, display, or analysis.

The PC 104 is display-agnostic, in that it seamlessly operates with any one of a variety of popular screen technologies using an appropriate graphics adapter, such as a super-VGA (SVGA) adapter. In various embodiments, the screen 112 is one of a plasma display, a projection display, a cathode ray tube, a liquid crystal display, an organic light emitting diode display, an electronic, ink display, or any other screen capable of displaying time-varying media. In one embodiment, a single PC 104 operates and displays content on a plurality of screens 112.

The PC 104 generally maintains its playlists in a database 124 in a local memory. A PC 104 may also have a default playlist, to be utilized in the absence of a specified playlist. The playlists specify what content the PC 104 displays on which screens 112 and at what times. The PC 104 includes a command-processing module that listens at a particular port for received messages, parses a received message, and instructs the PC 104 to take appropriate actions in response to the message.

Each PC 104 includes a management control center (MCC) 128, which permits an administrator to create and define playlists for controlling the operation of the PC 104 hosting the MCC 128 or another PC 104′. The playlists may be stored locally at the PC 104 or they may be stored at the CC 100, to facilitate later processing or distribution. The operation of the MCC 128 is described in greater detail hereinbelow.

In a further embodiment, the PC 104 includes logging functionality to record what content items are shown, at what times, and for what duration. This logged information is available to an administrator operating the PC 104 and may be provided to the CC 100 at regular, irregular, or otherwise scheduled intervals. This logging information may be used for billing, diagnostics for the system, and general auditing.

The PC 104 may interact with a CC 100 through the network 108 to retrieve content for its associated screen 112 as described above or, in the absence of a network connection, may rely on its locally-cached content to drive the display of screen 112. In those embodiments utilizing a CC 100, the PC 104 may advise the CC 100 if a piece of content in a playlist is present in local memory at the PC 104, if instead the playlist content must be transmitted from the CC 100 to the PC 104, and the presence status for all of the content items cached in local memory at the PC 104.

The user device 116 is any device capable of wired line or wireless communications. Suitable user devices 116 for use with the present invention include, for example, a cell phone or a PDA capable of interfacing with short message service (SMS) or multimedia messaging service (MMS) gateways. In a first embodiment, the user device 116 interacts with a CC 100 through the UC 120 by generating dual tone multi-frequency (DTMF) sounds that serve as proxies for particular commands. In another embodiment, the user device 116 interacts with a CC 100 over a conventional “plain-old telephone service” (POTS) connection to the UC 120; the CC 100 serves as an interactive voice response (IVR) system, accepting a combination of DTMF tones and voice telephone input. In a further embodiment, the user device 116 is a cellular phone that interacts with a CC 100 through a UC 120 using SMS or MMS. In these embodiments, the user devices 116 forward user content such as SMS text or MMS images to the CC 100 through the UC 120 in an appropriate format. In still another embodiment, the user device 116 transmits ISDN commands, which are interpreted as corresponding to key presses on the user device 116.

The PC 104 receives input from a user device 116 through the UC 120 and, in response, displays the requested content on the screen 112. The CC 100 also returns information to the user device 116 through the UC 120. For example, the CC 100 may acknowledge information from a user device 116 (e.g., “Got your SMS entry, thank you.”) Winners of competitions are notified through the UC 120 to the winner's user device 116 and are authenticated by a unique winner ID configured at the PC 104.

The UC 120 interacts with user devices, 116, receiving commands and information from an end user and providing them to the CC 100 for processing, sending the results of the processing to the appropriate screen 112. In one embodiment, the UC 120 is implemented as a software program executing on CC 100; in another embodiment, the UC 120 is a separate hardware device.

An optional super controller (SC) 132 lets a single administrator control a plurality of CCs 100. The CCs 100 may be located at the sane site, or they may scattered across disparate locations. The SC 132 interacts with each CC, 100 over the network 108, permitting world wide control and configuration of CCs 100.

These devices are configured using parameters in a configuration file stored at the device. The device reads the configuration file at initialization and configures its operation according to the specified parameters. The device may also receive a command indicating that a particular configuration file has been revised and either actively download or passively receive a revised configuration file in response to the command. This permits the devices to be configured during operation without taking the devices off-line.

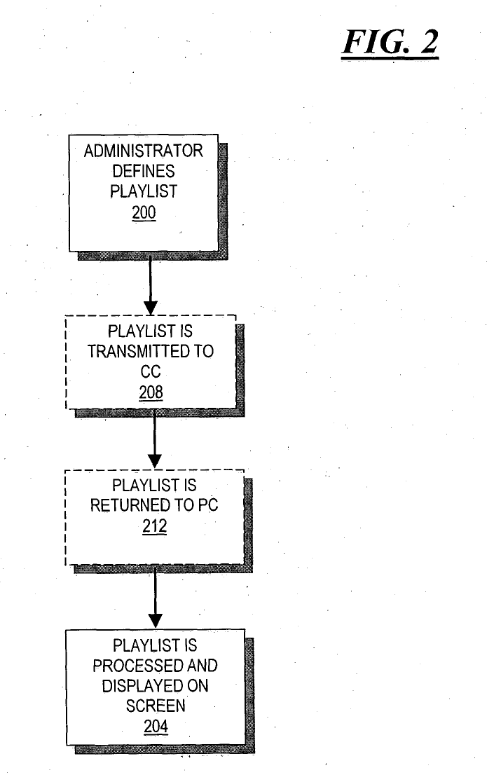

With reference to FIG. 2, in operation, an administrator at the PC 104 defines a playlist of content items that the administrator wants displayed at a screen 112 (Step 200). The PC 104 subsequently processes the playlist, displaying the specified content items at the times and intervals defined in the playlist on the screen 112 (Step 204). In one embodiment, the newly-created playlist is transmitted to the CC 100 for storage (Step 208) before it is returned for display to the PC 104 that originated it or to another PC 104 (Step 212). This feature permits the remote administration of one or more screens 112 and provides security for the content items, as discussed in greater detail below.

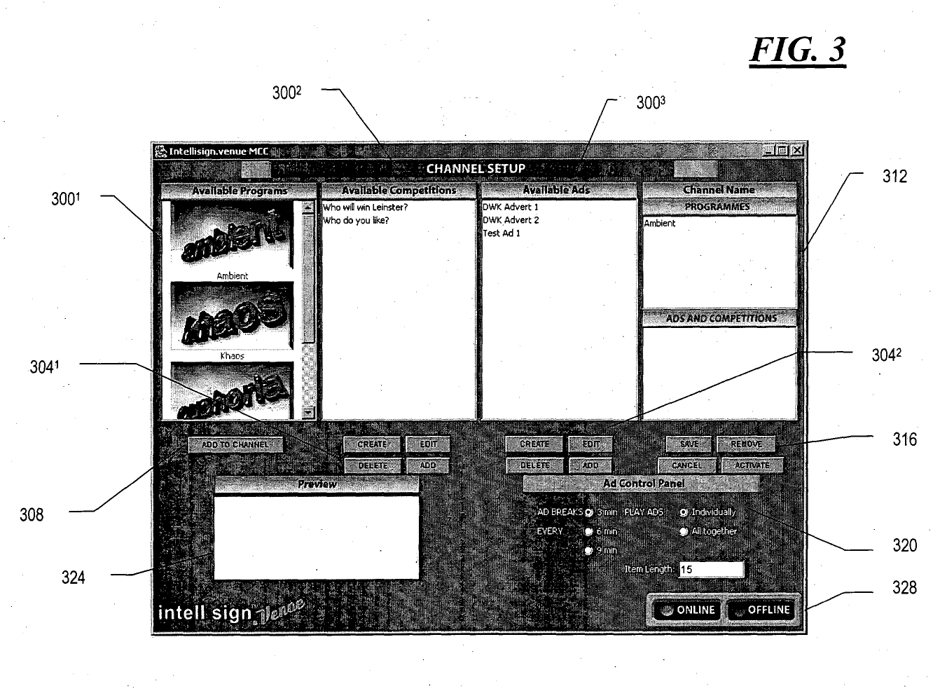

The PC 104 lets an administrator specify a playlist using a management control console (MCC), illustrated in FIG. 3. In this embodiment, the MCC is an executable computer program, written in JAVA, that displays a graphical user interface (GUI) that lets the administrator specify a playlist. In other embodiments, the MCC is provided as an executable or interpretable computer program written using programming languages such as JAVA, C++, or TCL. In one embodiment, this computer program is downloaded and executed using a web browser on a remote computer that subsequently uses the downloaded program to control the PC 104, providing remote management tool (RMT) functionality.

In accord with the present invention, an administrator may also create a playlist using tools such as a word processor or hexadecimal editor, but the GUI presented by the MCC greatly simplifies the creation of playlists. Using the MCC 116, an administrator can also edit, revise, or otherwise make changes to a playlist. The playlist, once edited, nay be forwarded back to the CC 100 for storage. In one embodiment, the playlists are stored as XML files on disk.

The MCC includes several content panes 300¹, 300², 300³ (generally 300) that present available content items for selection by an administrator for incorporation into a playlist. In operation, a playlist defines a series of content for display by a particular sign 112. Each piece of content is identified by a unique content id and is associated with a set of parameters permitting its scheduling and management, such as its start time and duration.

Pane 300¹ presents available programs, which are templates analogous to “screen savers” used on desktop computers. Pane 300² presents administrator-generated applications such as available competitions, which are opinion polls or surveys that present a user with a question and prompt the selection or entry of an answer. Pane 300³ presents external content (i.e., content items not, generated by the administrator) such as available advertisements. Other panes 300 in accord with the present invention allow the selection of live TV channels, pre-recorded programs, songs, music videos, still images, virtual billboards that let the administrator or other users post messages for public display, and other forms of media content such as multiuser games. For example, a PC 104 operating in accord with the present invention can present a graphical display of output from a multiplayer game and accept commands from each of the players' user devices 116, updating the state of the multiplayer game in response to the received commands.

Each pane is associated with a cluster of controls 304 that permit an operator of the MCC to “Create,” “Edit,” “Delete,” or “Add” content items identified in the pane 300. Selecting the “Create” item creates a line entry in the associated pane 300 that conveniently identifies a selectable content for incorporation into a playlist. For example, an administrator selects the “Create” button to create an interactive quiz that presents viewers with an opinion survey asking for the predicted outcome of a sporting event and presenting the viewers with a choice of teams playing. The administrator associates the title “Who will win Leinster?” with the quiz and it appears in the pane 300² for subsequent selection. The administrator selects the “Create” button again to create a competition allowing users to express their approval or disapproval of a photo provided to the PC 104 using, e.g., a camera-equipped cell phone. The administrator associates the title “Who do you like?” with this competition and it appears in the pane 300² for subsequent selection. Once created, a content item may be deleted using the “Delete” button or edited using the “Edit” button. The “Add” button permits the importation of pre-existing content items, permitting administrators of different PCs 104 to collaborate and share content.

Highlighting a program from panel 300¹, a competition from panel 300², an ad from panel 300³, or some other content item from another panel, and selecting the “Add to Channel” button 308 adds the content item to the playlist and causes it to be displayed in the channel panel 312. In the embodiment of FIG. 3, the administrator has selected the “Ambient” program for inclusion into the playlist; as indicated by the channel panel 312.

Using the associated control cluster 316, the administrator can “Save,” “Remove,” “Cancel,” or “Activate” the current playlist. Selecting “Save” writes a record of the programmed playlist to persistent memory for storage and subsequent use, while selecting “Cancel” abandons the playlist currently under construction. Highlighting an individual program, ad, or competition from the channel panel 312 and selecting the “Remove” control will remove the selected item from the playlist. Selecting the “Activate” button activates the playlist, displaying it on an associated screen 112 in accord with the options and content specified.

An administrator controls the interspersion of advertising and competitions with content using the “Ad Control Panel” control cluster 320. The cluster 320 lets the administrator specify the time between advertising spots and control whether the set of advertisements and competitions is displayed one at a time or sequentially. In a further embodiment, the MCC also includes recurrence functionality, such that an administrator can define a playlist with content that recurs at a certain interval (e.g., every minute, every hour, every day, certain day(s) of the week, every nth day(s) of the month, etc.).

A preview pane 324 lets the administrator preview available content items or the playlist currently under construction.

A status indicator 328 indicates whether the PC 104 (see FIG. 1) has a live network connection to the CC 100 through the network 108. The presence of a live network connection lets the CC 100 stream content items to the PC 104 for display, permitting the secure and controlled distribution of copyrighted content. In this embodiment, when a content item is selected for display that is only available from the CC 100 and no network connection is present, the PC 104 selects another content item from display that is available locally or omits the display of the absent item. In another embodiment, all of the selected content items are retrieved from the CC 100 when a network connection is available and cached at the PC 104 for later display. Similarly, the absence of a network connection causes the removal or replacement of interactive content items in the playlist such as competitions; in the absence of a connection to the CC 100 and, in turn, the UC 120, received commands cannot be processed and passed to the PC 104 for display at a screen 112. In a further embodiment, the PC 104 attempts to establish a network connection to the CC 100 to renew its access to the content on the CC 100 when no network connection is present.

Using the MCC, an administrator groups PCs 104 or screens 112 by name, function, or tag, permitting a single administrator to handle the configuration of multiple devices. This feature enables remote administration, as the physical devices themselves may be geographically distant from the administrator's location, and cloning, where a display is configured to operate in an identical mode to a master device.

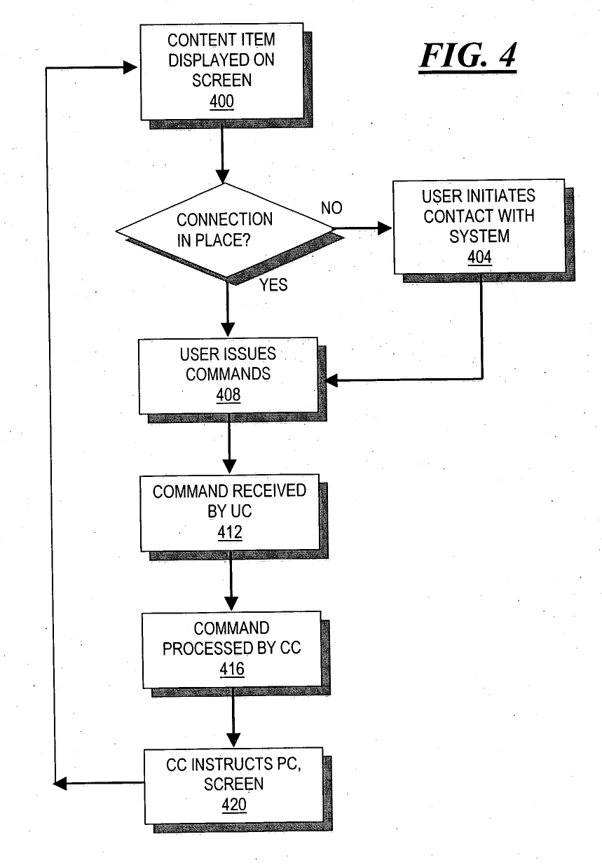

FIG. 4 depicts a flowchart of an exemplary interaction between a user and an embodiment of the present invention. A PC 104 executing a specified playlist displays a content item on a screen 112 (Step 400). A user views the displayed content item and initiates a connection, e.g., a telephone call, a VoIP call, or a wireless connection, to a telephone number or network address presented in the display of the content item (Step 404). Once connected, the user issues one or more commands (Step 408) that are received by the UC 120 (Step 412) and provided to the CC 100 for subsequent storage (Step 416) and later retrieval to effectuate the specified user commands.

After processing the commands, the CC 100 provides instructions to the PC 104 to display the results of the processing on a screen 112 (Step 420). In one embodiment, the CC 100 provides this signal to the UC 120, which in turn transmits it through the network 108 using UDP to the PC 104. Upon processing the received messages, the PC 104 requests content from the CC 100 using a request over network 108 to the CC 100. The CC 100, upon receiving a valid request, transmits the requested content to the PC 104 and logs the transaction in its logging module. The process repeats as the screen 112 updates its displayed content to reflect the result of the transaction (Step 400).

Exemplary Embodiments

In embodiments where the user device 116 is a cellular telephone, the user may see a telephone number and an optional sign number displayed on the screen 112 (Step 400). The user dials the telephone number, and when prompted, enters the optional sign number to inform the CC 100 of the particular PC 104 and screen 112 for subsequent interactions (Step 404). The user issues subsequent commands (Step 408) using DTMF tones for an IVR system or SMS/MMS for a cellular network, where they are received by the UC 120 (Step 412) and provided to a CC 100 acting as an IVR system for processing (Step 416).

Various DTMF tones and combinations of DTMF tones may be mapped to predetermined-commands through the functionality provided by the IVR system. Exemplary commands include: order ringtones, order downloadable items, order news items, order sports items, order lifestyle items, order games, order children's content, order educational material, order teen content, order financial content, order video content, order adult content, order music content, or order locale-specific content.

The IVR system presents these choices using pre-recorded messages or machine-generated speech. In other embodiments, the CC 100 works in concert with a PC 104 and a screen 112 to graphically present these menu items to a user. In these embodiments, the CC 100 creates a playlist on-the-fly containing the graphical menu items by executing a program and transmitting the created playlist to the PC, 104 for display on a screen 112 (Step 420). The process repeats as a user views the menu items (Step 400) and issues commands based on the graphical display (Step 408). For example, a user may press a key on a phone corresponding to a menu item presented on the display.

The UC processes the received commands and passes the result to a PC 104 using XML data structures over a network 108 (Step 420). This XML information encodes image information, character information, and binary control signals that are transferred through the network 108.

The PC 104 displays the playlist on a screen 112 as discussed above. If the PC 104 requires files or other data to complete its display, it requests that information from the CC 100. As each content item is played, users are invited to watch or interact with the system as appropriate: watching television content or recorded programs, listening to songs, participating in contest, surveys, and games, etc.

In this embodiment, the UC 120 includes the modules listed in Table 1—implemented in either software, hardware, or a combination thereof—to process data from user devices 116:

TABLE 1
UC 120 MODULES

| | |
|---|---|
| UC 3.1 | Module to verify user identity |
| UC 3.2 | Module to handle IVR user interactions with the CC 100 |
| UC 3.3 | Module to process SMS request for content display |
| UC 3.4 | Module to process SMS request for ring tone or logo or other |
| | data to download |
| UC 3.5 | Module to receive new user menu |
| UC 3.6 | Module to receive new sign configuration |

and the CC 100 includes the modules listed in Table 2—implemented in either software, hardware, or a combination thereof:

TABLE 2
CC 100 MODULES

| | |
|---|---|
| CC 2.1 | Module to construct news feed playlists |
| CC 2.2 | Module to dispatch news feed playlists |
| CC 3.1 | Module to receive initial configuration from PC 104 |
| CC 3.2 | Module to send outgoing commands |
| CC 3.3 | Module to send new configuration details |
| CC 3.4 | Module to acknowledge new configuration details |
| CC 3.5 | Module to send personalized content to an PC 104 |
| CC 3.6 | Module to receive details of SMS content download |
| CC 3.7 | Module to receive content display acknowledgement |
| | from PC 104 |
| CC 3.8 | Module to receive details of user interactions from PC |
| | 104 |
| CC 4.1 | Module to validate user's phone number and send |
| | content items to locker controller |
| CC 4.2 | Module to request a job resend, or a ring tone or logo |
| | download |
| CC 4.3 | Module to receive content information |
| CC 4.4 | Module to record recurring content and take items on or |
| | off the playlist as per internal system clock |
| CC 4.5 | Module to interact with the SC so as to allow the SC to |
| | control a number of CCs as the system scales in number |
| CC 4.6 | Module to interact with the remote management tool |
| | (RMT) so that MCC-like functionality can be provided to |
| | a central administrator when a local administrator cannot |
| | be available |

In one exemplary interaction involving an embodiment of the present system, a PC 104 is initialized and sends a message to the CC 100 announcing its presence and identity using, e.g., one or more UDP messages. The CC 100 receives the messages from the PC 104, logs their receipt, sends one or more messages to the PC 104 acknowledging the messages from the PC 104, and provides a playlist to the PC 104 that is tailored to the identity information provided by the PC 104. The PC 104 processes the playlist, displaying the results on an attached screen 112. The first content item on the playlist is a survey application asking viewers to decide “Who is the best DJ in Boston?” The content item presents the viewers with a list of four choices and instructions on how to provide their vote: e.g., “Send an SMS message with ‘Club A’ and your answer to 617-555-1212.” The message prompting the user to vote may also include additional information such as the cost of the SMS message required to transmit the user's vote.

The user composes an SMS message of “Club A—DJ C,” i.e., a vote for DJ C in response to a survey (called ‘DJ’ in this example) offered at Club A, and send it to 617-555-1212. The SMS message is received at the UC 120 and forwarded to the CC 100 or received at the CC 100 directly through the network 108. The received message is spell checked and filtered for expletives either at the UC 120 or at the CC 100. Additional processing of the message at the CC 100, or the UC 120 may reveal that, for example, the message was sent at an inappropriate time, such as before the beginning of the contest, or after the end of the contest.

An optional response to the user device 116 is provided either directly through the network 108 or through the UC 120, such as “Thank you for your entry of C for SURVEY ‘Who is the best DJ in Boston?’. Please watch the main club screen for results.” The user votes are further processed by the CC 100 into a bar chart using, for example, a template specified by the administrator operating the PC 104, and provides the graphic to the PC 104 for insertion into the playlist and display for the audience.

Locker Functionality

In accord with the present invention, the system may present a display of content items and commands that is secure and particular to a specific user using, for example, a web page. Using these “locker pages,” a user saves favorite playlists for future display. These favorite playlists are then sent over a network 108 for display at a user device 116. These playlists may include virtually any displayable or audible content, such as text, still images, movies and sound files. Typical locker content includes news, sports, and financial information. This content may be time-sensitive or location-sensitive, such that the content only displays during a specific time window or on specific devices in a predetermined area. The locker also provides links to popular downloads and to channels of thematic content. The inventive system supports subscriptions such that a user can access premium information on an unlimited or per-item cost basis.

The locker functionality is implemented using data stored on a database 124 on CC 100. The database stores records of a user's past purchases and favorite content items. The content items themselves may be stored on a CC 100, a PC 104, or some combination thereof, as discussed above.

A user sends content stored in his locker to a user device 116 by selecting a menu command instructing the CC 100 to transmit the content through the network 108 to the user device 116. The locker page is constructed such that each supported user device 116 is associated with a unique identifier on the web page. The CC 100 may optionally prompt the user to confirm the request for content before beginning the transmission. For each supported user device 116, the CC 100 stores information on codes and carriers used to download ringtones and graphics to a cell phone.

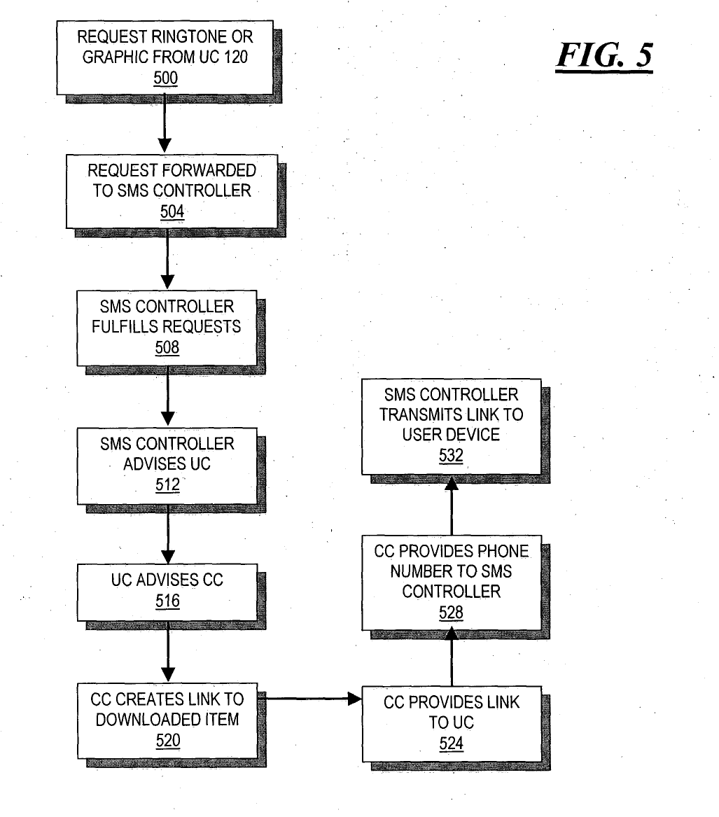

As depicted in FIG. 5, a user having established a connection with the CC 100 through the UC 120 sends a message to the UC 120 requesting download of a ringtone or graphic (Step 500). The UC 120 forwards the request to an SMS controller (Step 504). The SMS controller transmits the selected item to the user's phone (Step 508) and advises the UC 120 of fulfillment (Step 512). The UC 120 informs the CC 100 that the request has been fulfilled (Step 516) and, in response, the CC 100 creates a content item containing the link for display (Step 520). The CC 100 informs the UC 120 of the download location (Step 524), and the UC 120 in turn provides this information to the SMS controller, along with the user's telephone number or identifying token (Step 528). The SMS controller transmits the download location to the user's phone using the user's phones number.

Since the functionality for ordering ringtones and graphics or other data involves the dynamic generation of hypertext content in response to the receipt of user commands, the apparatus and methods of the present invention may be used to provide a secure system of information kiosks or any other application requiring the dynamic generation and personalized delivery of information.

In one exemplary interaction involving an embodiment of the present system having locker functionality, a user of the system interacts with a display or visits a website offering content items for purchase and download for a user device. As part of the registration or login process, the user provides a device identifier, such as a mobile phone number, that uniquely identifies the user device, permitting the system to automatically retrieve billing and security information associated with the user or the user device. The user purchases a content item (e.g., a single song, a ringtone, a graphic, a news item, a stock price) and indicates that the content item is to be stored for future retrieval using locker functionality or transmitted to the user device at a specified time (for example, immediately). The system may process the purchase transaction using the associated stored billing information or, in one embodiment, may prompt the user for billing information to be used for the transaction.

System Protocols

In operation, communications between a CC 100 and a PC 100 preferably utilize two high-level protocols implemented on top of lower-level protocols such as UDP/IP or TCP/IP. The first protocol, control protocol (“CP”) is a lightweight high performance protocol used by the CC 100 to control a PC 104 and, in turn, screens 112 attached to the PC 104.

The second protocol is implemented on top of HTTP using XML and is called file transfer (“FT”) protocol. FT is a robust protocol used for communications involving the CC 100 that include file data, content data, and structured XML data.

Messages sent using these protocols are self-contained, in that each message typically includes a command for execution as well as the parameters associated with the execution of that command. In one embodiment, the command is contained in the first byte of the message, and the parameters fill the remaining bytes in the message.

These protocols are dynamic, in that the structure of the messages and their content is specified in a file, e.g., an XML file, stored at each controller in the system. The file specifies any correspondence between a particular byte in a message and a particular data field and the data fields associated with particular commands (detailed below). A controller receiving a message consults the file to determine which bytes represent which parameters; a controller transmitting a message will similarly consult the file to determine the parameters to be included with each command and map this information to the correct bytes in the message. Using a file to define the protocol permits the protocol to be revised without taking the controllers off-line by providing a file implementing the revised protocol and transmitting it to the other controllers in the network;

Table 3 illustrates the protocol used as a function of the sending machine and the receiving machine and describes the messages sent between machines:

TABLE 3
PROTOCOLS USED FOR SYSTEM COMMUNICATIONS

| | Central Controller | User Controller | Player Controller |
|---|---|---|---|
| | Transmitting | Transmitting | Transmitting |
| Central | — | UC retrieves a list of | Player polls |
| Controller | | active signs on receipt | competition |
| Receiving | | of incoming CP | content from |
| | | message from the CC. | the CC using |
| | | | HTTP. It |
| | | | also sends |
| | | | activity XML |
| | | | from the sign. |
| User | CC sends | — | N/A: PC does |
| Controller | UC a CP | | not send |
| Receiving | message to | | data directly |
| | indicate that | | to the UC; |
| | the list of | | PC routes |
| | available signs | | data to UC |
| | has changed. | | using CC. |
| Player | CC sends | N/A: UC | — |
| Controller | Player CC | communicates with | |
| Receiving | messages | PCs through CC | |
| | indicating new | | |
| | content maybe | | |
| | updated results | | |
| | of polls etc. | | |

The commands transmitted using these protocols are loosely categorized into four classes: System Commands, Configuration Commands, User Commands, and Content Commands. System commands are sent to the PC 104 and instruct the PC 104 to perform maintenance operations, such as shutdown or reinitialization. Configuration commands are sent to a device on the network 108 indicating that a configuration file has been updated and providing a location, e.g., a CC 100, where the latest version of the configuration file may be obtained. User commands contain details of user requests. Content commands coordinate the downloading and viewing of content (e.g., video content, ringtones, graphics) by users.

Many alterations and modifications may be made by those having ordinary skill in the art without departing from the spirit and scope of the invention. Therefore, it must be expressly understood that the illustrated embodiment has been shown only for the purposes of example and should not be taken as limiting the invention, which is defined by the following claims. These claims are thus to be read as not only including literally what is set forth by the claims but also to include those equivalents which are insubstantially different even though not identical in other respects to what is shown and described in the above illustrations.

What is claimed is:

1. An apparatus for interactive media display comprising:
a central controller to provide content items for display on a screen;
a player controller for receiving the content items from the central controller through a network; and
a screen for displaying content specified by the player controller,
wherein at least one of the central controller and the player controller is responsive to a user communication device operable by a user to select the content items for display.

2. The apparatus of claim 1 wherein the screen is one of a cathode ray tube display, a liquid crystal display, a plasma display, an, organic light-emitting diode display, an electronic ink display, and a projection screen display.

3. The apparatus of claim 1 wherein the user device is a portable communication device.

4. The apparatus of claim 3 wherein the user device is one of a mobile phone, a GSM phone, a fixed line telephone, a handheld computer with wireless data capability a DTMF-generating, apparatus associated with a telephone voice input, and a remote control having an infrared (IR) transmitter.

5. The apparatus of claim 1 wherein the user device generates DTMF tones to direct operation of the central controller.

6. The apparatus of claim 1 wherein the user device generates SMS messages to directs operation of the central controller.

7. The apparatus of claim 1 wherein the user device generates MMS messages to direct operation of the central controller.

8. The apparatus of claim 1 wherein the central controller executes a program whose output displays at the screen.

9. The apparatus of claim 1 wherein the central controller displays predetermined material when a user is not selecting content items for display on the screen.

10. The apparatus of claim 1 further comprising a second screen for the receipt of content items selected by a user via the user device.

11. The apparatus of claim 10 wherein the second screen is mounted on a mobile phone device.

12. The apparatus of claim 10 wherein the second screen is mounted on the user device.

13. The apparatus of claim 1 wherein the content item is at least one of a live TV channel, a pre-recorded program, a song, a music video, a still image, a virtual billboard, or a multiplayer interactive game.

14. The apparatus of claim 1 wherein the content item is a pointer to at least one of a live TV channel, a pre-recorded program, a song, a music video, a still image, a virtual billboard, or a multiplayer interactive game.

15. A method for interactive media display comprising:
providing a plurality of content items organized as a playlist;
causing sequential display of the items on a screen;
receiving a command from a remote source;
processing the received command; and
displaying a new content item in response to the received command.

16. The method of claim 15 further comprising providing a content item to a user device in response to the received command.

17. The method of claim 16 wherein the provided content item is at least one of ringtones, WAP content, graphics, and data.

18. The method of claim 15 wherein the content item displayed in response to the received command is provided to a second screen.

19. The method of claim 18 wherein the second screen is mounted on a mobile phone device.

20. An apparatus four the generation of an interactive media display comprising:
a content system for the creation of a playlist of content items;
a network interface for providing the playlist to a display system; and
a display system comprising:
a central controller to provide content items for display on a screen;
a player controller for receiving the content items from the central controller through a network; and
a screen for displaying content specified by the player controller.

21. The apparatus of claim 20 wherein the playlist is transmitted to the central controller for storage.

22. The apparatus of claim 20 further comprising a second screen for the provision of content items selected by a user.

23. The apparatus of claim 22 wherein the second screen is mounted on a mobile phone device.

24. An apparatus for, interactive media display comprising:
a player controller in communication with a network the player controller receiving content items transmitted from a remote database server;
a screen in communication with the player controller, the screen displaying the received content items;
a user device for selecting a content item from a menu of content items displayed on the screen; and
a computational module that receives information from the user device and selects a content item for display on the screen in response to the received information.

25. The apparatus of claim 24 further comprising a locker module for storing previously requested content items.

26. The apparatus of claim 24 wherein the information received from the user device is provided in XML format.

27. The apparatus of claim 24 wherein the information received from the user device includes a start time and a reception channel for the desired content.

28. The apparatus of claim 24 further comprising a second screen for the provision of content items selected by a user.

29. The apparatus of claim 28 wherein the second screen is mounted on a mobile phone device.

30. The apparatus of claim 28 wherein the second screen is mounted on the user device.

31. A method for interactive media display comprising:
indicating, on a display screen, a plurality of selectable content items;
receiving a transmission over a network in response to a command transmitted by a portable communication device, the transmission including a specification of at least one of the content items; and
facilitating display of the at least one content item on a display device associated with the portable communication device.
